(19) United States
(12) Patent Application Publication
(10) Pub. No.: US 2005/0100427 A1
(43) Pub. Date: May 12, 2005

(54) Fastening member

(76) Inventor: Jen-Kui Chang, Feng-Yuan City (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/788,551

(22) Filed: Feb. 26, 2004

(30) Foreign Application Priority Data
Nov. 6, 2003 (TW) 092219721

(51) Int. Cl. F16B 15/00

(52) U.S. Cl. 411/451.3

(57) ABSTRACT

A fastening member includes a root portion, and a driven portion. The root portion has a first end and a second end and has a mediate portion formed with two elongated slots. The driven portion has an end extended from the first end of the root portion so that the root portion is combined with the driven portion to form a substantially L-shaped body. Thus, the fastening member is combined with the workpieces rigidly and stably without detachment, so that the workpieces are closely combined together.

### BACKGROUND OF THE INVENTION

1. Field of the Invention

The present invention relates to a fastening member, and more particularly to a fastening member that is combined with the workpieces rigidly and stably without detachment, so that the workpieces are closely combined together.

2. Description of the Related Art

A conventional fastening member, such as a nail or the like, is used to combine two workpieces together. Usually, the conventional fastening member comprises a bar-shaped shank having a sharp point, and a disk-shaped head mounted on the shank. The shank is located at a center of the head. Thus, the conventional fastening member form a substantially T-shaped structure. However, the shank of the conventional fastening member has a smooth surface, so that the shank is easily detached from the two combined workpieces, thereby detaching the two workpieces.

### SUMMARY OF THE INVENTION

The present invention is to mitigate and/or obviate the disadvantage of the conventional fastening member.

The primary objective of the present invention is to provide a fastening member that is combined with the workpieces rigidly and stably without detachment, so that the workpieces are closely combined together.

Another objective of the present invention is to provide a fastening member, wherein the root portion has a first face formed with a convex arc-shaped surface and a second face formed with a concave arc-shaped surface, so that the fastening member has an enhanced structural strength.

A further objective of the present invention is to provide a fastening member, wherein the ratchet portions of the root portion are closely engaged with the workpieces to prevent the fastening member from detaching from the workpieces.

In accordance with the present invention, there is provided a fastening member, comprising a root portion, and a driven portion, wherein:
the root portion has a first end and a second end, the root portion has a mediate portion formed with two elongated slots; and
the driven portion has an end extended from the first end of the root portion.

Further benefits and advantages of the present invention will become apparent after a carefull reading of the detailed description with appropriate reference to the accompanying drawings.

### BRIEF DESCRIPTION OF THE DRAWINGS

FIG. 1 is a perspective view of a fastening member in accordance with the preferred embodiment of the present invention;

FIG. 2 is a plan cross-sectional view of the fastening member taken along line 2-2 as shown in FIG. 1;

FIG. 3 is a perspective assembly view showing the fastening member being combined with two articles;

FIG. 4 is a plan cross-sectional view of the fastening member and the two articles as shown in FIG. 3;

FIG. 5 is a plan cross-sectional view of the fastening member and the two articles as shown in FIG. 3;

FIG. 6 is a schematic operational view of the fastening member as shown in FIG. 5;

FIG. 7 is a partially enlarged view of the fastening member as shown in FIG. 6.

### DETAILED DESCRIPTION OF THE INVENTION

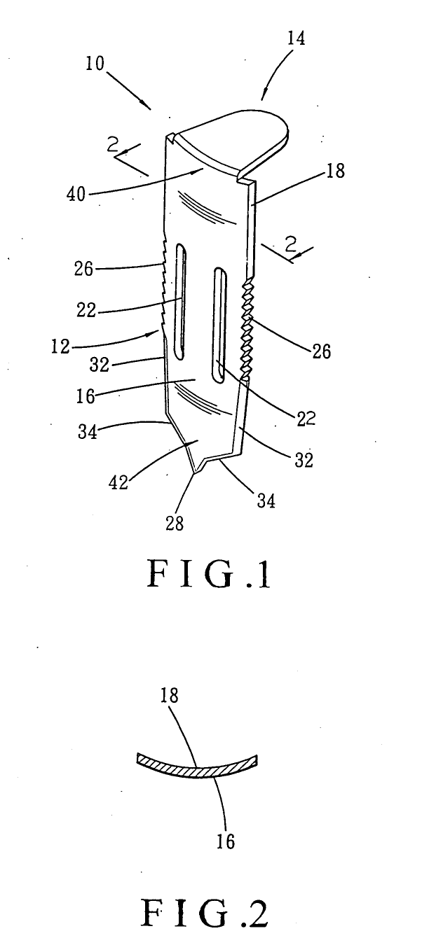

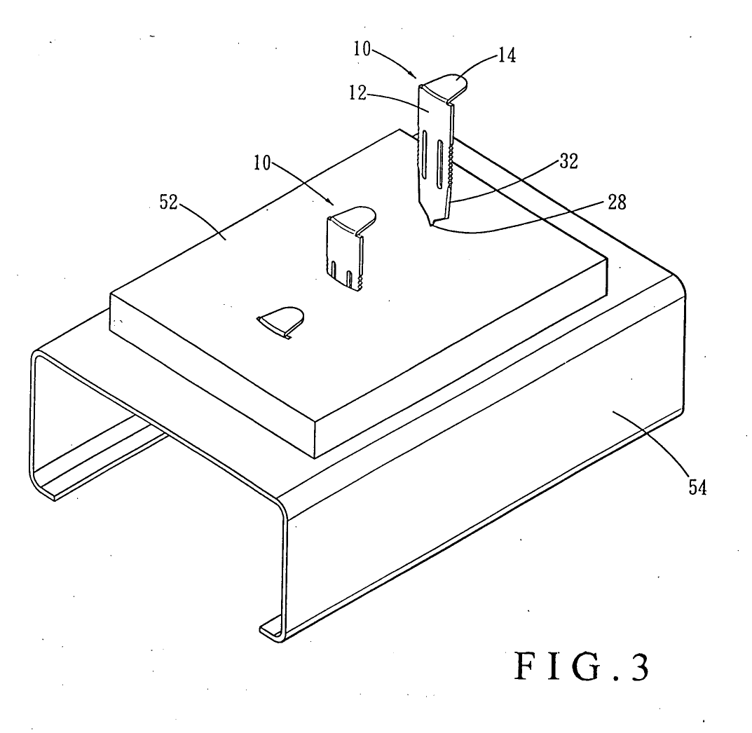

Referring to the drawings and initially to FIGS. 1-3, a fastening member 10 in accordance with the preferred embodiment of the present invention comprises a root portion 12 and a driven portion 14.

The root portion 12 is a sheet plate and has a first end 40 and a second end 42. The root portion 12 has a first face formed with a convex arc-shaped surface 16 and a second face formed with a concave arc-shaped surface 18. Thus, the root portion 12 has an enhanced structural strength. The root portion 12 has a mediate portion formed with two elongated slots 22. Each of the two elongated slots 22 is extended along a longitudinal direction of the root portion 12. The root portion 12 has two opposite sides each formed with a ratchet portion 26. The ratchet portion 26 of each of the two opposite sides of the root portion 12 is directed toward the first end 40 of the root portion 12. The second end 42 of the root portion 12 has two opposite sides each formed with an inclined face 32 having a first end located adjacent to the respective ratchet portion 26, an oblique blade 34 having a first end extended from a second end of the inclined face 32, and a tip 28 extended from a second end of the oblique blade 34. The inclined faces 32 of the two opposite sides of the second end 42 of the root portion 12 have a width smaller that that of the root portion 12.

The driven portion 14 has a planar shape and has an end extended from the first end 40 of the root portion 12. The driven portion 14 is vertical to the root portion 12, so that the root portion 12 is combined with the driven portion 14 to form a substantially L-shaped body.

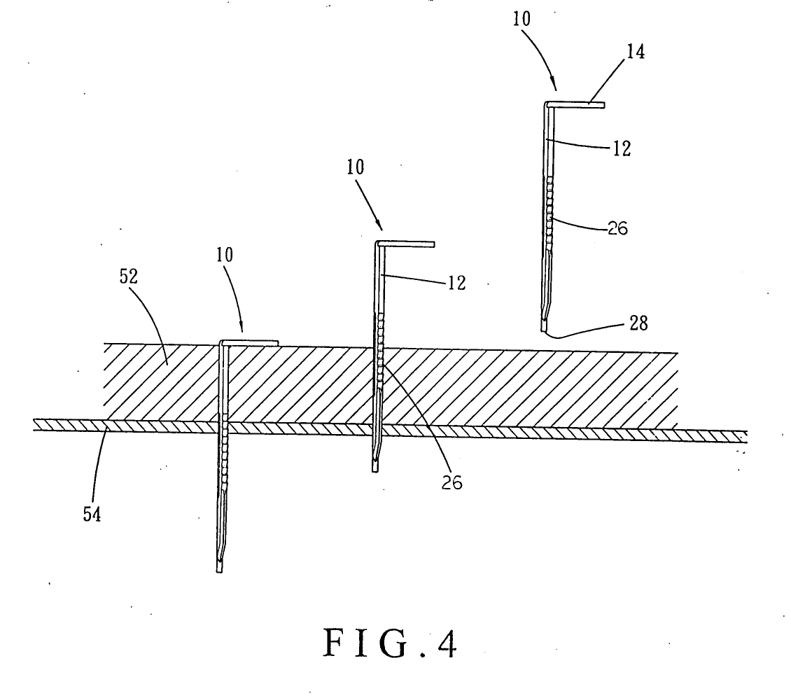

In operation, referring to FIGS. 1-7, the fastening member 10 is used to combine two articles 52 and 54 together. The two articles 52 and 54 are juxtaposed with each other. Then, the tip 28 of the root portion 12 of the fastening member 10 is rested on the article 52, and a striking force is applied on the driven portion 14 of the fastening member 10 by a hammer or the like, to in turn force the tip 28 of the root portion 12 of the fastening member 10 into the article 52 and the article 54.

At this time, the oblique blades 34 of the root portion 12 of the fastening member 10 are guided by the tip 28 to move with the root portion 12 so as to cut the articles 52 and 54 successively, so that the root portion 12 of the fastening member 10 is moved in the articles 52 and 54 smoothly and conveniently.

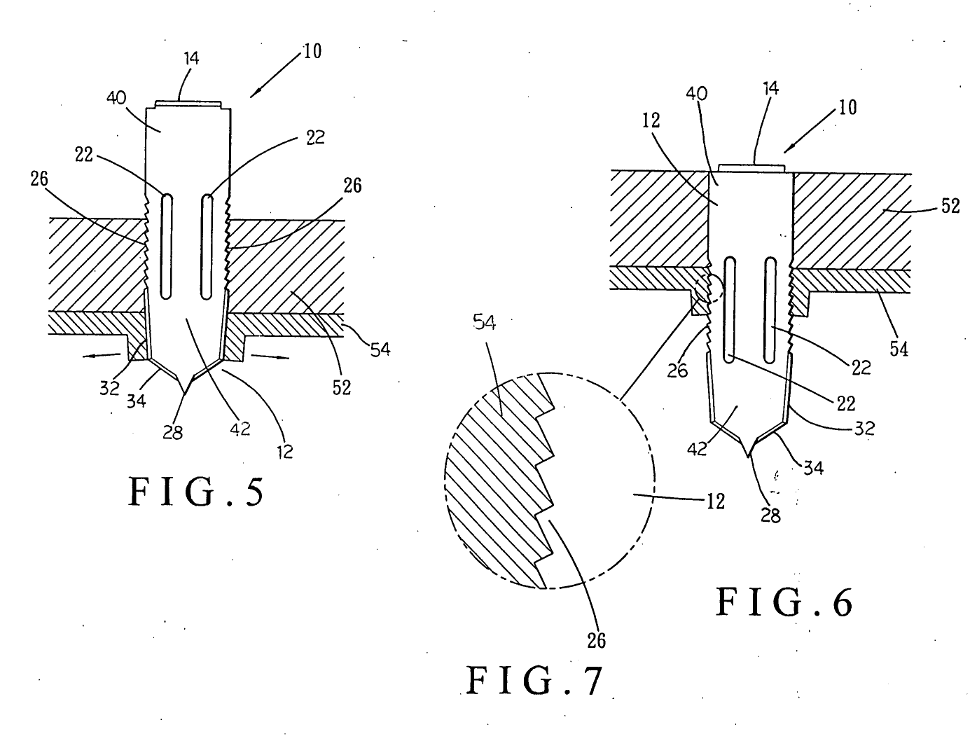

After the root portion 12 of the fastening member 10 is forced into the articles 52 and 54 as shown in FIG. 5, the root portion 12 of the fastening member 10 is elastically compressed inward by provision of the two elongated slots 22 to reduce the width of the root portion 12 of the fastening member 10, so that the root portion 12 of the fastening member 10 is moved in the articles 52 and 54 easily and conveniently. In addition, the inclined faces 32 facilitates movement of the root portion 12 of the fastening member 10 in the articles 52 and 54.

After the second end 42 of the root portion 12 of the fastening member 10 is detached from the articles 52 and 54 as shown in FIG. 6, the root portion 12 of the fastening member 10 is elastically expanded outward by provision of the two elongated slots 22 to restore the width of the root portion 12 of the fastening member 10, so that the root portion 12 of the fastening member 10 is combined with the articles 52 and 54 rigidly and stably. In addition, the ratchet portions 26 of the root portion 12 are directed toward the first end 40 of the root portion 12 as shown in FIG. 7 to engage the articles 52 and 54 closely to prevent the root portion 12 from moving back in the articles 52 and 54, so that the root portion 12 of the fastening member 10 is combined with the articles 52 and 54 rigidly and stably without detachment.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A fastening member, comprising a root portion, and a driven portion, wherein:
the root portion has a first end and a second end, the root portion has a mediate portion formed with two elongated slots; and
the driven portion has an end extended from the first end of the root portion.

2. The fastening member in accordance with claim 1, wherein the root portion is a sheet plate.

3. The fastening member in accordance with claim 1, wherein the, root portion has a first face formed with a convex arc-shaped surface and a second face formed with a concave arc-shaped surface.

4. The fastening member in accordance with claim 1, wherein each of the two elongated slots is extended along a longitudinal direction of the root portion.

5. The fastening member in accordance with claim 1, wherein the root portion has two opposite sides each formed with a ratchet portion.

6. The fastening member in accordance with claim 5, wherein the ratchet portion of each of the two opposite sides of the root portion is directed toward the first end of the root portion.

7. The fastening member in accordance with claim 5, wherein the second end of the root portion has two opposite sides each formed with an inclined face having a first end located adjacent to the respective ratchet portion, an oblique blade having a first end extended from a second end of the inclined face, and a tip extended from a second end of the oblique blade.

8. The fastening member in accordance with claim 7, wherein the inclined faces of the two opposite sides of the second end of the root portion have a width smaller that that of the root portion.

9. The fastening member in accordance with claim 1, wherein the driven portion has a planar shape.

10. The fastening member in accordance with claim 1, wherein the driven portion is vertical to the root portion, so that the root portion is combined with the driven portion to form a substantially L-shaped body.
